(19) United States
(12) Patent Application Publication
(10) Pub. No.: US 2022/0058527 A1
(43) Pub. Date: Feb. 24, 2022

(54) SYSTEM AND METHOD FOR AUTOMATED DETECTION AND PREDICTION OF MACHINE FAILURES USING ONLINE MACHINE LEARNING

(71) Applicant: Aktiebolaget SKF, Göteborg (SE)

(72) Inventors: David LAVID BEN LULU, Yokneam Illit (IL); Olga ROSSINSKY, Haifa (IL); Aleksandr TOLSTOV, Saint Petersburg (RU); Waseem GHRAYEB, Nazareth Illit (IL); Roman BONDARCHUK, Utrecht (NE); Yurii DOVZHENKO, Kiev (UA)

(73) Assignee: Aktiebolaget SKF, Göteborg (SE)

(21) Appl. No.: 17/497,243

(22) Filed: Oct. 8, 2021

Related U.S. Application Data
(63) Continuation of application No. PCT/US2020/027062, filed on Apr. 7, 2020.
(60) Provisional application No. 62/832,467, filed on Apr. 11, 2019.

(51) Int. Cl. G06N 20/00; G05B 23/02

(52) U.S. Cl. CPC G06N 20/00; G05B 23/0254

(57) ABSTRACT

Disclosed herein a method and machine monitoring system for predicting failures of industrial machines. The system is configured to receive sensor data related to a machine, such as large industrial machinery, and select indicative data features for machine failures. The system then applies an unsupervised machine failure detection process and a supervised machine failure prediction process to the selected indicative data feature. When new sensor data of the machine is received, a machine failure detection process is applied to the selected at least one indicative data feature that is associated with the new sensor data. This allows the disclosed system to determine whether at least one machine failure indicator was detected and if so, the machine failure is tagged. Then, the system updates the supervised machine failure prediction process with the new tagged machine failure indicators, such that the supervised machine failure prediction process is continuously updated and improved.

### CROSS-REFERENCE TO RELATED APPLICATIONS

This application is a continuation of International Application No. PCT/US2020/027062 filed on Apr. 7, 2020, which claims the benefit of U.S. Provisional Application No. 62/832,467 filed on Apr. 11, 2019, the contents of which are hereby incorporated by reference.

### TECHNICAL FIELD

The present disclosure relates generally to maintenance systems for machines, and more specifically to automatically detecting and predicting machine failures using online machine learning for continuous improving and adaptive prediction models.

### BACKGROUND

Communications, processing, cloud computing, artificial intelligence, and other computerized technologies have advanced significantly in recent years, heralding in new fields of technology and production. Further, many of the industrial technologies employed since or before the 1970s are still used today. Existing solutions related to these industrial technologies have typically seen minor improvements, thereby only slightly increasing production and yield.

In modern manufacturing practices, manufacturers are often required to strict production timelines and provide flawless or nearly flawless production quality. As a result, these manufacturers risk heavy losses whenever an unexpected machine failure occurs. A machine failure is an event that occurs when a machine deviates from correct operation. Errors, which are deviations from a correct or expected state of the machine, are not necessarily failures, but may lead to and indicate potential future failures. Additionally, errors may otherwise cause unusual machine behavior that may affect performance.

The average failure-based machine downtime for typical manufacturers (i.e., the average amount of time in which production shuts down, either in part or in whole, due to machine failure) is 17 days per year, i.e., 17 days of lost production and revenue. In the case of a typical 450, megawatt power turbine, for example, a single day of downtime can cost a manufacturer over $3 million US in lost revenue. Such downtime may have additional costs related to repair, safety precautions, and the like.

In energy power plants, billions of dollars are spent annually on ensuring reliability, specifically on backup systems and redundancies utilized to minimize production downtimes. Additionally, monitoring systems may be utilized to identify failures quickly, thereby speeding up the return to production when downtime does occur. However, existing monitoring systems typically identify failures only after or immediately before downtime begins.

Some existing monitoring and maintenance solutions use detection capabilities in order to predict forthcoming machine failures. Such solutions are based on data gathered by sensors coupled to such machines. The processing of sensor data is limited to the signals gathered by the sensors and limited to static prediction. However, these solutions have several deficiencies, such as becoming outdated and irrelevant as the machine data changes, requiring ongoing maintenance for the prediction mechanisms, static prediction and detection models used to process dynamic data, and so on.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include an online machine learning based method for detection and prediction of industrial machine failures. The method comprises receiving sensor data related to at least one industrial machine; generating a plurality of data features based on at least a portion of the sensor data; selecting, from the plurality of data features, at least one indicative data feature for a machine failure detection; applying to the selected at least one indicative data feature an unsupervised machine failure detection process, wherein the unsupervised machine failure detection process is configured to detect machine failure indicators based on the selected at least one indicative data feature; receiving new sensor data related to the at least one industrial machine; determining, by applying the unsupervised machine failure detection process to the selected at least one indicative data feature that is associated with the new sensor data, whether at least one machine failure indicator were detected in the new sensor data; and tagging the at least one machine failure indicator upon determination that the at least one machine failure indicator were detected, wherein upon determination that no machine failure indicators were detected, the unsupervised machine failure detection process continuously searches for machine failure indicators.

Certain embodiments disclosed herein also include a system for online machine learning based method for detection and prediction of industrial machine failures. The system comprises a processing circuitry; and a memory, the memory containing instructions that, when executed by the processing circuitry, configure the system to: receive sensor data related to at least one industrial machine; generate a plurality of data features based on at least a portion of the sensor data; select, from the plurality of data features, at least one indicative data feature for a machine failure detection; apply to the selected at least one indicative data feature an unsupervised machine failure detection process, wherein the unsupervised machine failure detection process is configured to detect machine failure indicators based on the selected at least one indicative data feature; receive new sensor data related to the at least one industrial machine; determine, by applying the unsupervised machine failure detection process to the selected at least one indicative data feature that is associated with the new sensor data, whether at least one machine failure indicator were detected in the new sensor data; and tag the at least one machine failure indicator upon determination that the at least one machine failure indicator were detected, wherein upon determination that no machine failure indicators were detected, the unsupervised machine failure detection process continuously searches for machine failure indicators.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a machine management server according to an embodiment.

FIG. 3 is a flowchart illustrating a method for automated detection and prediction of machine failures according to an embodiment.

FIG. 4A is an example graph illustrating a training process of a machine failure detection process according to an embodiment.

FIG. 4B is an example graph illustrating application of a machine failure detection or prediction process to new sensor data according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and machine monitoring system for predicting machine failures using machine learning techniques. In an embodiment, the machine monitoring system is configured to receive sensor data related to a machine, such as large industrial machinery, and select indicative data features for machine failures. The system then applies an unsupervised machine failure detection process and a supervised machine failure prediction process to the selected indicative data feature. When new sensor data of the machine is received, a machine failure detection process is applied to the selected at least one indicative data feature that is associated with the new sensor data. This allows the disclosed system to determine whether at least one machine failure indicator was detected and if so, the machine failure is tagged. Then, the system is configured to automatically update the supervised machine failure prediction process with the new tagged machine failure indicators, such that the supervised machine failure prediction process is continuously updated and improved.

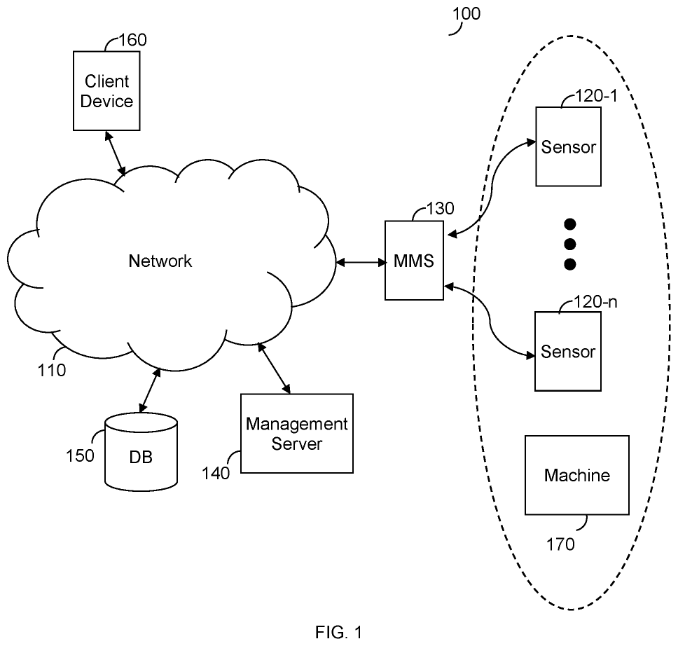

FIG. 1 shows an example network diagram 100 utilized to describe the various disclosed embodiments. The example network diagram 100 includes a machine monitoring system (MMS) 130, a management server 140, a database 150, and a client device 160 communicatively connected via a network 110. The example network diagram 100 further includes a plurality of sensors 120-1 through 120-n (hereinafter referred to individually as a sensor 120 and collectively as sensors 120, merely for simplicity purposes), where n is an integer equal to or greater than 1, connected to the machine monitoring system 130. The network 110 may be, but is not limited to, a wireless network, a cellular or wired network, a local area network (LAN), a wide area network (WAN), a metro area network (MAN), the Internet, the worldwide web (WWvV), similar networks, and any combination thereof.

The client device 160 may be, but is not limited to, a personal computer, a laptop, a tablet computer, a smartphone, a wearable computing device, or any other device capable of receiving and displaying notifications indicating maintenance and failure timing predictions, results of supervised analysis, unsupervised analysis of machine operation data, and the like.

The sensors 120 are located in proximity (e.g., physical proximity within a predetermined threshold) to an industrial machine 170. The industrial machine 170 may be any machine for which performance can be represented via sensor data such as, but not limited to, a turbine, an engine, a welding machine, a three-dimensional (3D) printer, an injection molding machine, a combination thereof, a portion thereof, and the like.

Each sensor 120 is configured to collect sensor inputs such as, but not limited to, sound signals, ultrasound signals, light, movement tracking indicators, temperature, energy consumption indicators, and the like based on operation of the machine 170. The sensors 120 may include, but are not limited to, sound capturing sensors, motion tracking sensors, energy consumption meters, temperature meters, and the like. Any of the sensors 120 may be, but are not necessarily, connected to the machine 170 (such connection is not illustrated in FIG. 1 merely for the sake of simplicity and without limitation on the disclosed embodiments).

The sensors 120 are connected to the machine monitoring system 130. The machine monitoring system 130 may be configured to store and preprocess raw sensor data received from the sensors 120. Alternatively, or collectively, the machine monitoring system 130 may be configured to periodically retrieve collected sensor data stored in, for example, the database 150.

The preprocessing may include, but is not limited to, data cleansing, normalization, rescaling, re-trending, reformatting, noise filtering, a combination thereof, and the like. The preprocessing may further include data feature extraction. The results of the data feature extraction may include data features to be utilized by the management server 140 during machine learning in order to detect data features that indicate on machine failures as the machine failures occur, or on forthcoming machine failure as further described herein below.

In an embodiment, the management server 140 may be configured to identify in time-stamped sensor data a plurality of data features represented by at least a statistical feature. The plurality of data features represent behavior of at least a component of the machine. The data feature extraction may include, but is not limited to, dimension reduction techniques such as, but not limited to, singular value decompositions, discrete Fourier transformations, discrete wavelet transformations, line segment methods, or a combination thereof. When such dimension reduction techniques are utilized, the preprocessing may result in, e.g., a lower-dimensional space for the sensory inputs. The machine monitoring system 130 is configured to send the preprocessed sensory inputs to the management server 140.

In an embodiment, the management server 140 is configured to receive, via the network 110, time-stamped sensor data that is associated with at least one machine, e.g., the machine 170. The time-stamped sensor data may be received from the machine monitoring system 130. The time-stamped sensor data may be received from one or more sensors, e.g., the sensors 120. The sensor data may be received constantly and may be received in real-time. Each type of sensor data may be related to at least a process that is associated with the machine, executed by the machine, and the like. That is, a first type of sensor data may be related to the temperature of the industrial machine 170, a second type of sensor data may be related to the speed of a certain gear of the machine 170, and so on. In a further embodiment, the management server 140 is configured to receive preprocessed sensor data.

In an embodiment, the management server 140 may be configured to store the sensor data (raw, preprocessed, or both) received from the machine monitoring system 130. Alternatively, or collectively, the sensor data may be stored in the database 150. The database 150 may further store sensory inputs (raw, preprocessed, or both) collected from a plurality of other sensors (not shown) associated with other machines (also not shown). The database 150 may further store indicators, anomalous patterns, behavioral trends, failure predictions, machine learning models utilized for analyzing sensory input data, or a combination thereof. In an embodiment, the management server 140 is configured to preprocess the raw sensory inputs as further described herein above.

In an embodiment, the management server 140 is configured to generate one or more data features based on the received sensor data. The data features may be represented by mathematically calculated features. In a further embodiment, the generation may be executed by transforming the preprocessed sensor data and/or each type of the raw sensor data into one or more data features that are represented by mathematically calculated features. The data features may be a mathematic representation of the raw sensor data allowing to represent the sensor data in a more clarified manner. The generation may be achieved using at least one statistical analysis technique. Statistical analysis technique may include, but is not limited to, computing mean for the raw sensory inputs, computing median for the raw sensory inputs, computing standard deviation for the raw sensory input, and the like.

In an embodiment, implementing the statistical analysis techniques on the raw, or preprocessed, sensor data allows the management server 140 to generate the plurality of data features. The data features allow to facilitate the identification of an association between a plurality of anomalies associated with a plurality of processes related to the machine 170. That is, the data features are new and informative representation of the raw, or preprocessed sensor data, allow for the identification of hidden structures in the raw sensor data. In a further embodiment, the transformation includes reducing the size of the raw sensor data, for example, by transforming raw data in seconds resolution into indicative minutes resolution. The transformation may include singular value decompositions, discrete Fourier transformations, discrete wavelet transformations, line segment methods, and the like.

In a further embodiment, the transformation includes normalizing the raw sensor data and/or preprocessed sensor data to a uniform scale. That is, the raw sensor data may be presented in different scales and therefore the management server 140 can be configured to normalize the raw sensor data by generating a uniform scale for all raw sensor data. The sensor data may include a particular gear sensed by a first sensor, oil temperature sensed by a second sensor, and so on. The uniform scale may be utilized to identify an association between the different types of sensor data, a correlation between abnormal behaviors of the different types of sensor data, and the like.

In an embodiment, the management server 140 is configured to select from the plurality of data features at least one indicative data feature for a machine failure detection and/or machine failure prediction. Indicative data features are representation of the sensor data, that when analyzed, allowing to more accurately indicate a machine failure and/or a forthcoming machine failure, with respect to other data features having less contribution to a machine failure prediction process or to a machine failure detection process.

In an embodiment, the selection of indicative data features is performed by scanning the large and comprehensive database of features to obtain two subsets of informative features for detection and prediction. Indicative data features may include descriptive statistics features. The indicative features for event detection are indicative to machines failures once such failures already happened. For example, an indicative data feature for machine failure detection may be related to water temperature, revolutions per minute (RPM) of a certain industrial machine component, and so on. The indicative features for failure prediction are indicative features which show gradual degradation before failures occur. For example, an indicative data feature for event prediction may be related to vibrations' sound level of the industrial machine, oil pressure of a certain component of the industrial machine, and so on. It should be noted that sensory inputs sensed by the same sensor may be used by the management server 140 for detecting and predicting events in the industrial machine 170. For example, oil pressure may be an indicative data feature for machine failure detection and it may also be an indicative data feature for machine failure prediction. The feature selection is performed iteratively at each re-training iteration of a supervised model.

In a further embodiment, a plurality of indicative data features may be selected based on at least a distribution of the plurality of data features. The distribution may indicate a developing association between the plurality of data features towards a machine failure. In an embodiment, the distribution may indicate on an association between the plurality of data features during a machine failure.

In a further embodiment, at least one indicative data feature is selected from a plurality of data features based on a probability to predict machine failures and/or detect machine failures. For example, an industrial machine (e.g., the machine 170) including five components is being monitored and during a certain period of time the parameters of three indicative data features, associated with three components of the machine 170, indicate on abnormal parameters of each of the components.

According to the same example, the management server 140 may determine that the distribution of the indicative data features, i.e., the abnormal parameters of each of them, indicate an association between the three indicative data features that may be indicative of a forthcoming machine failure. In a further embodiment, the selection of the indicative data features having a better probability to contribute more to predicting a machine failure, with respect to other data features, may be achieved by identifying an increasing change in the data feature distribution prior to a machine failure with respect to a normal state of the machine.

In an embodiment, the management server 140 is configured to apply on the selected indicative data feature an unsupervised machine failure detection process and a supervised machine failure prediction process. The unsupervised machine failure detection process is configured to detect machine failure indicators based on the selected indicative data feature. A machine failure indicator may be, for example, a value associated with a certain parameter of at least a component of a machine, e.g., the machine 170, indicating on a machine failure. For example, an oil temperature of 90 degrees Celsius of a certain industrial machine may be classified as an indicator to a machine failure.

The supervised machine failure prediction process is configured to predict machine failures based on the selected indicative data feature. In an embodiment, the unsupervised machine failure detection process and the supervised machine failure prediction process may be applied to at least a portion of the time-stamped sensor data that is previously tagged, or labeled, with respect to one or more machine failure indicators. Thus, by applying the process on the tagged, or labeled, sensor data, a training phase is achieved. The training phase may include recording characteristics associated with each machine failure indicator such as the average values of the machine failures, duration, and the like.

In an embodiment, the management server 140 is configured to receive new sensor data related to the at least a machine, e.g., the machine 170. The new sensor data may include at least a portion of information received from at least one sensor, e.g., the sensors 120, that the management server 140 never processed before. That is, the new sensor data may include, for example, machine failures that have not been recorded or tagged before. In an embodiment, the new sensor data may be associated with one or more of the components of the at least a machine 170. For example, while the same sensor data is received with respect to a first component of the machine 170, at least a new set of data is received with respect to three other components of the machine 170.

In an embodiment, the management server 140 is configured to determine, by applying the unsupervised machine failure detection process to the selected indicative data feature, or indicative data features, whether one or more machine failure indicators were detected in the new sensor data. The unsupervised machine failure detection process is designed to detect machine failure indicators and new machine failure indicators.

In an example, ten machine failure indicators are detected in the sensor data. When new sensor data is received at the management server 140, two more new machine failure indicators are detected. In an embodiment, the new machine failure indicators may be associated with machine components that have never indicated a machine failure previously. In a further embodiment, the new machine failure indicators may be associated with a known machine failure type of a machine component but in a different new scale. For example, a new machine failure indicator may indicate on an abnormal behavior represented by the revolutions per minute (RPM) of the machine engine which is a parameter that never indicated on a machine failure before. According to another example, the new machine failure indicator may indicate an abnormal behavior of the machine represented by the oil temperature of the machine which is a parameter that indicated on machine failures many times before but in a different scale.

In an embodiment, the management server 140 is configured to tag the one or more machine failure indicators upon determination that the one or more machine failure indicators were detected. In an embodiment, an electronic tag may be generated and associated with each new machine failure indicator. The electronic tag may include descriptive information related to the machine failure indicators such as a title indicating the type of the failure, the level of failure, and the like.

In an example, new levels of vibrations of a certain machine are detected by the machine failure detection process and classified as machine failure. According to the same example, the new level of vibrations, i.e., the values associated with the new levels of vibrations, are tagged by the management server 140. The tag may include, for example, the values of the new level of vibrations, the time at which the new level of vibrations were detected, the sensors that were utilized to sense the new level of vibrations, the machine components that are affected by the new level of vibrations, and so on. It should be noted that, upon determination that no machine failure indicators were detected, the unsupervised machine failure detection process continuously searches for machine failure indicators.

In an embodiment, the management server 140 is configured to update the supervised machine failure prediction process with the tagged one or more machine failure indicators, such that the supervised machine failure prediction process is continuously updated. By updating the machine failure prediction process with the new tagged machine failure indicators, the prediction capabilities of the machine failure prediction process remain high over time. That is, the machine failure prediction process is trained, using the method disclosed herein, to predict machine failures even after long periods of time with no human intervention. Predicting machine failures may include identifying patterns, trends, etc. indicated by the machine sensor data as further discussed herein above.

In one example, the embodiments disclosed herein allow to detect and predict downtime of an industrial machine. To this aim, the management server 140 requires an initial labeled period where the failures are knowns and marked. This labeled time range can either be provided by the customer in the form of a failure log, or generated internally in case no such log is available. When log data is not available, the disclosed management server 140 is configured to continue the initial training and generate of two machine learning models: one for failure detection and another for failure prediction (each based on the relevant subset of the indicative features.

These initial trained models are being constantly updated in the course of time (in order to be adaptive to changes and new types of failures). Each new failure which is detected by the management server 140 is also fed back into the management server 140 and is used to re-train both the detection and prediction models on-the-fly. Once the updated models are trained and prepared, they replace the previous models and are applied to the new streaming data, and the procedure continuous iteratively.

In an embodiment, the disclosed method is based on online machine learning techniques. Online machine learning is a method of machine learning in which data becomes available in a sequential order and is used to update the most indicative predictors for future data at each step, as opposed to batch learning techniques which generate the most indicative predictors by learning on the entire training data set at once. That is, by using the disclosed method, the process of determining whether new machine failure indicators were detected occurs continuously, as well as the tagging process and the updating process of the supervised machine failure prediction process, that also occur continuously.

In an embodiment, the disclosed method may be achieved using semi-supervised learning. Semi-supervised learning is a class of machine learning tasks and techniques that typically uses a small amount of labeled data with a large amount of unlabeled data. When using semi-supervised learning, the process is required to learn from a dataset that includes both labeled and unlabeled data. Semi-supervised technique is a combination of supervised and unsupervised machine learning methods. One such technique includes completing the unlabeled samples with an unsupervised machine learning method and then permitting the application of supervised methods on the complete labeled dataset.

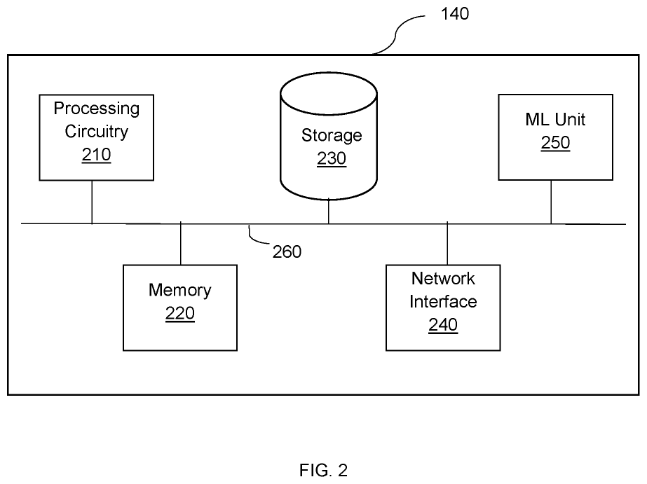

FIG. 2 shows an example block diagram of the management server 140 implemented according to one embodiment. The management server 140 includes a processing circuitry 210 coupled to a memory 220, a storage 230, a network interface 240, and a machine learning (ML) processor 250. In an embodiment, the components of the management server 140 may be communicatively connected via a bus 260.

The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 220 may be volatile (e.g., RAM), non-volatile (e.g., ROM, flash memory, and the like.), or a combination thereof. In one configuration, computer readable instructions to implement one or more embodiments disclosed herein may be stored in the storage 230.

In another embodiment, the memory 220 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein.

The storage 230 may be magnetic storage, optical storage, and the like, and may be realized, for example, as flash memory or other memory technology, CD-ROM, Digital Versatile Disks (DVDs), SSDs, or any other medium which can be used to store the desired information.

The network interface 240 allows the management server 140 to communicate with the machine monitoring system 130 for the purpose of, for example, receiving raw and/or preprocessed sensory inputs. Additionally, the network interface 240 allows the management server 140 to communicate with the client device 160 in order to send, e.g., notifications related to machine anomalous activity, machine failure prediction, etc.

The machine learning process 250 is configured to perform machine learning processor based on sensor data received via the network interface 240 as described further herein. In an embodiment, the machine learning unit 250 is further configured to predict machine failures, update one or more machine failure prediction processes, and the like. The machine learning process 250 may be realized, for example, as a GPU, a TPU, general-purpose microprocessors, a DSP, and the like.

It should be understood that the embodiments described herein are not limited to the specific architecture illustrated in FIG. 2, and other architectures may be equally used without departing from the scope of the disclosed embodiments.

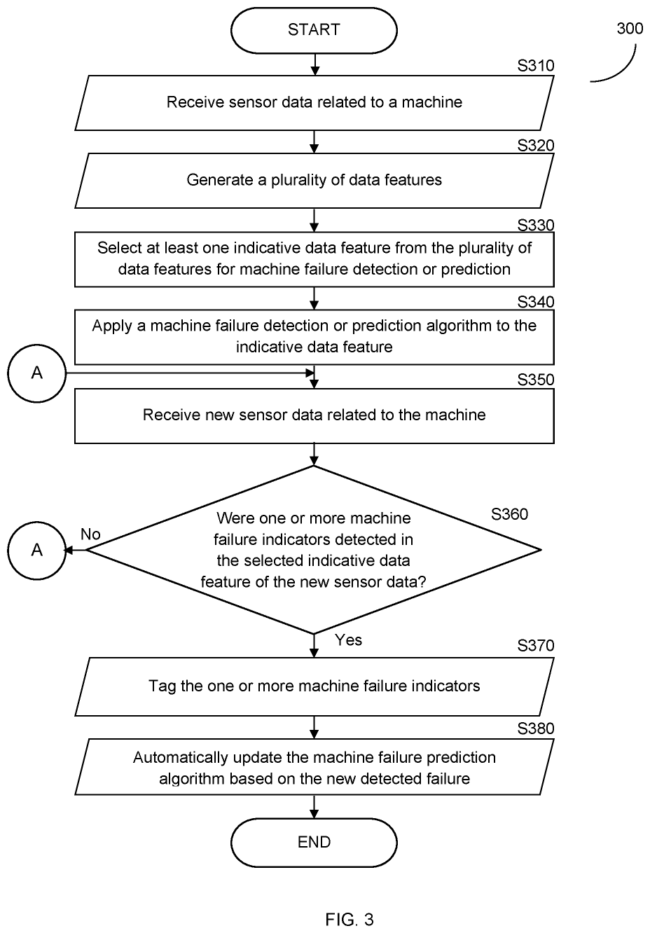

FIG. 3 is an example flowchart 300 illustrating a method for detection and prediction of machine failures according to an embodiment. In an embodiment, the method may be performed by the machine failure predictor 140 (see FIGS. 1 and 2).

At S310, a time-stamped sensor data related to at least an industrial machine (e.g., the machine 170) is received. The time-stamped sensor data may be received from one or more sensors of the machine 170. Each type of the sensor data may be related to at least a process that is associated with the machine, executed by the machine, and the like.

At S320, a plurality of data features is generated based on at least a portion of the time-stamped sensor data. The data features are extracted using data extraction techniques. The data feature extraction may include, but is not limited to, dimension reduction techniques such as, but not limited to, singular value decompositions, discrete Fourier transformations, discrete wavelet transformations, line segment methods, or a combination thereof. In an embodiment, a data feature may be represented by at least a statistical feature and/or may represent behavior of at least a component of the industrial machine.

At S330, at least one indicative data feature for at least one of a machine failure detection and machine failure prediction, is selected from the plurality of data features.

Indicative data features are representation of the sensor data, that when analyzed, allowing to more accurately indicate a machine failure and/or a forthcoming machine failure, with respect to other data features having less contribution to a machine failure prediction process or to a machine failure detection process. As discuss above, the indicative data features may be selected based on at least a distribution of the plurality of data features.

At S340, an unsupervised machine failure detection process and a supervised machine failure prediction process are process to the selected at least one indicative data feature. The unsupervised machine failure detection process is configured to detect machine failure indicators based on the selected at least one indicative data feature and the supervised machine failure prediction process is configured to predict machine failures based on the selected at least one indicative data feature as further discussed with respect of FIG. 1.

At S350, new sensor data related to the machine is received. The new sensor data may include at least a portion of information received from at least one sensor, e.g., the sensors 120, that the management server 140 never processed before, such as values of a certain component that have reached to a new level.

At S360, it is determined whether one or more machine failure indicators were detected in the received new sensor data based on the selected at least one indicative data feature, and if so, execution continues with S370; otherwise, execution continues with S350. The determination is achieved by applying the unsupervised machine failure detection process to the new sensor data or to the selected at least one indicative data feature associated with the new sensor data. It should be noted that upon determination that no machine failure indicators were detected, the unsupervised machine failure detection process continuously searches for machine failure indicators.

At S370, the one or more machine failure indicators are tagged upon determination that one or more machine failure indicators were detected. In an embodiment, an electronic tag may be generated and associated with each new machine failure indicator that was detected. The electronic tag may include descriptive information related to the machine failure indicators as further discussed herein above.

At S380, the supervised machine failure prediction process (applied before) is updated with the tagged one or more machine failure indicators. In some embodiments, semi-supervised or self -supervised approach may be utilized as well. It should be noted that the supervised machine failure prediction process is continuously updated. It should be further noted that updated and tagged one or more machine failure indicators may be merged with known, or old, sensor data that is associated with the machine, e.g., the machine 170, that was previously detected and stored at, e.g., the database 150.

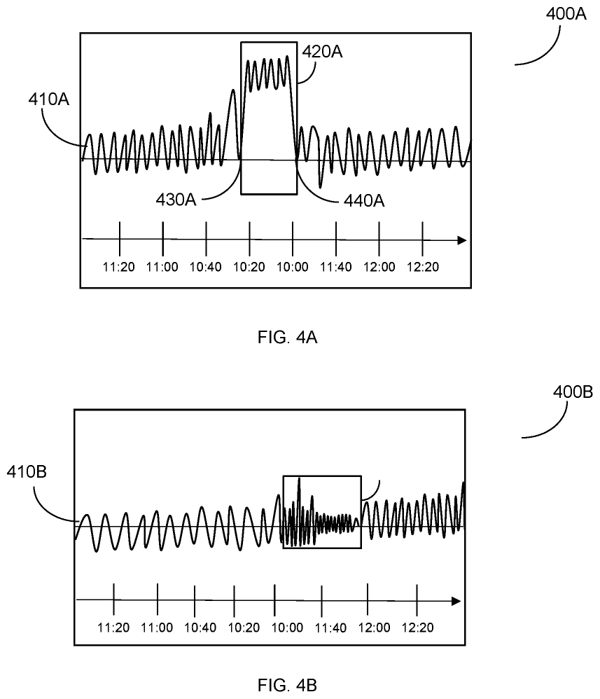

FIG. 4A is an example graph 400A illustrating representation of a training process of a machine failure detection process according to an embodiment. The graph shown in FIG. 4A includes a graph 400A in which a curve 410A is shown and represents sensor data of a certain parameter of a machine, such as the revolutions per minute (RPM) of the machine engine. The curve 420A represents a labeled machine failure provided to the machine failure detection process which is utilized to train the machine failure detection process to detect machine failures. A point at which the machine failure begins is indicated by 430A and a point at which the machine failure ends is indicated by 440A.

FIG. 4B is an example graph 400B illustrating representation of applying a machine failure detection and/or prediction process to a new sensor data according to an embodiment. The graph shown in FIG. 4B includes a graph 400B in which a curve 410B is shown and represents sensor data of a certain parameter of a machine such as the revolutions per minute (RPM) of the machine engine. The curve 420B represents a new machine failure detected by the machine failure detection process.

It should be noted that information related to each new detected machine failure is used as an input to the machine failure detection process as well as to the machine failure prediction process. The trained models, i.e., processes, are being constantly updated in the course of time in order to be adaptive to changes and new types of failures. Each new failure which is detected by the system is also fed back into the system and is used to re-train both the detection and prediction models in real-time or near real-time. Once the updated processes are trained above a certainty level, the updated processes replace the previous processes and are applied to the new streaming sensor data, and the method continuous iteratively.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. An online machine learning based method for detection and prediction of industrial machine failures, comprising:
receiving sensor data related to at least one industrial machine;
generating a plurality of data features based on at least a portion of the sensor data;
selecting, from the plurality of data features, at least one indicative data feature for a machine failure detection;
applying to the selected at least one indicative data feature an unsupervised machine failure detection process, wherein the unsupervised machine failure detection process is configured to detect machine failure indicators based on the selected at least one indicative data feature;
receiving new sensor data related to the at least one industrial machine;
determining, by applying the unsupervised machine failure detection process to the selected at least one indicative data feature that is associated with the new sensor data, whether at least one machine failure indicator were detected in the new sensor data; and
tagging the at least one machine failure indicator upon determination that the at least one machine failure indicator were detected, wherein upon determination that no machine failure indicators were detected, the unsupervised machine failure detection process continuously searches for machine failure indicators.

2. The method of claim 1, further comprising:
selecting, from the plurality of data features, at least one indicative data feature for machine failure prediction;
applying to the selected at least one indicative data feature a supervised machine failure prediction process;
wherein the supervised machine failure prediction process is configured to predict machine failures based on the selected at least one indicative data feature; and
updating the supervised machine failure prediction process with the tagged at least one machine failure indicator, such that the supervised machine failure prediction process is continuously and automatically updated and improved.

3. The method of claim 1, wherein the plurality of data features represents a behavior of at least a component of the at least a machine.

4. The method of claim 1, wherein the plurality of data features is generated based on at least one statistical method.

5. The method of claim 1, wherein the at least one indicative data feature is selected from the plurality of data features based on a probability to detect machine failures.

6. The method of claim 2, wherein the at least one indicative data feature is selected from the plurality of data features based on a probability to predict machine failures.

7. The method of claim 1, further comprising:
selecting a plurality of indicative data features from the plurality of data features based on at least a distribution of the plurality of indicative data features, wherein the at least a distribution indicates at least an association between the plurality of data features towards a machine failure.

8. The method of claim 1, wherein at least a portion of the sensor data is previously tagged with at least one machine failure indicator.

9. The method of claim 1, wherein determining whether at least one machine failure indicator were detected in the new sensor data is based on semi-supervised machine learning.

10. A non-transitory computer readable medium having stored thereon instructions for causing a processing circuitry to perform a process, the process comprising:
receiving sensor data related to at least one industrial machine;
generating a plurality of data features based on at least a portion of the sensor data;
selecting, from the plurality of data features, at least one indicative data feature for a machine failure detection;
applying to the selected at least one indicative data feature an unsupervised machine failure detection process, wherein the unsupervised machine failure detection process is configured to detect machine failure indicators based on the selected at least one indicative data feature;
receiving new sensor data related to the at least one industrial machine;
determining, by applying the unsupervised machine failure detection process to the selected at least one indicative data feature that is associated with the new sensor data, whether at least one machine failure indicator were detected in the new sensor data; and
tagging the at least one machine failure indicator upon determination that the at least one machine failure indicator were detected, wherein upon determination that no machine failure indicators were detected, the unsupervised machine failure detection process continuously searches for machine failure indicators.

11. A system for online machine learning based method for detection and prediction of industrial machine failures, comprising:
a processing circuitry; and
a memory, the memory containing instructions that, when executed by the processing circuitry, configure the system to:
receive sensor data related to at least one industrial machine;
generate a plurality of data features based on at least a portion of the sensor data;
select, from the plurality of data features, at least one indicative data feature for a machine failure detection;
apply to the selected at least one indicative data feature an unsupervised machine failure detection process, wherein the unsupervised machine failure detection process is configured to detect machine failure indicators based on the selected at least one indicative data feature;
receive new sensor data related to the at least one industrial machine;
determine, by applying the unsupervised machine failure detection process to the selected at least one indicative data feature that is associated with the new sensor data, whether at least one machine failure indicator were detected in the new sensor data; and
tag the at least one machine failure indicator upon determination that the at least one machine failure indicator were detected, wherein upon determination that no machine failure indicators were detected, the unsupervised machine failure detection process continuously searches for machine failure indicators.

12. The system of claim 11, wherein the system is further configured to:
select, from the plurality of data features, at least one indicative data feature for machine failure prediction;
apply the selected at least one indicative data feature a supervised machine failure prediction process;
wherein the supervised machine failure prediction process is configured to predict machine failures based on the selected at least one indicative data feature; and
update the supervised machine failure prediction process with the tagged at least one machine failure indicator, such that the supervised machine failure prediction process is continuously and automatically updated and improved.

13. The system of claim 11, wherein the plurality of data features represents a behavior of at least a component of the at least a machine.

14. The system of claim 11, wherein the plurality of data features is generated based on at least one statistical method.

15. The system of claim 11, wherein the at least one indicative data feature is selected from the plurality of data features based on a probability to detect machine failures.

16. The system of claim 12, wherein the at least one indicative data feature is selected from the plurality of data features based on a probability to predict machine failures.

17. The system of claim 1, wherein the system is further configured to:
select a plurality of indicative data features from the plurality of data features based on at least a distribution of the plurality of indicative data features, wherein the at least a distribution indicates at least an association between the plurality of data features towards a machine failure.

18. The system of claim 17, wherein at least a portion of the sensor data is previously tagged with at least one machine failure indicator.

19. The system of claim 17, wherein the system is further configured to:
determine whether at least one machine failure indicator were detected in the new sensor data is based on semi-supervised machine learning.
